(19) United States
(12) Patent Application Publication
(10) Pub. No.: US 2006/0271489 A1
(43) Pub. Date: Nov. 30, 2006

(54) Method for distributing digital books

(75) Inventors: Dennis Flanagan, Columbia, MD (US); David Easton, Columbia, MD (US)

Correspondence Address: BRYAN CAVE LLP, 211 NORTH BROADWAY, SUITE 3600, ST. LOUIS, MO, 63102-2750, US

(73) Assignee: MBS Textbook Exchange, Inc.

(21) Appl. No.: 11/436,414

(22) Filed: May 18, 2006

Related U.S. Application Data
(60) Provisional application No. 60/684,255, filed on May 25, 2005.

(51) Int. Cl. G06Q 99/00

(52) U.S. Cl. 705/52

(57) ABSTRACT

A method for facilitating access to electronic books and other similar digital materials includes first providing a digital book card having a card identification number and an activation code corresponding to the card identification number. The digital book card is also associated with an electronic book having an electronic book number. A retail store transaction is processed for the purchase of the electronic book associated with the digital book card. The transaction processing includes generating a receipt code that is associated with the card identification number. The retail store transmits the card identification number and the electronic book number to a central processor associated with a program administrator. The program administrator approves the transaction and provides a receipt code. A purchaser accessing a website associated with the central processor enters the card identification number, the activation code, and the receipt code. The purchase of the electronic book is authenticated in order to activate access to the electronic book by determining whether the card identification number entered by the purchaser corresponds to the activation code entered by the purchaser and whether the receipt code entered by the customer corresponds to the receipt code transmitted to the retail store by the central processor. If the authentication process is successful, access to the electronic book having the electronic book number associated with the card identification number is provided.

### RELATED APPLICATION INFORMATION

This application claims the benefit of U.S. Provisional Patent Application Ser. No. 60/684,255, filed on May 25, 2005, the disclosure of which is incorporated herein by reference in its entirety for all purposes.

### FIELD OF THE INVENTION

The present invention relates generally to the provision of electronic books and, more particularly, to a system and method for merchandising and distributing electronic books.

### BACKGROUND OF THE INVENTION

The use of digital or electronic textbooks, particularly in the collegiate environment, is expanding. The majority of electronic textbooks and other electronic course materials that are being sold to college students are merchandised by the respective publishers of the material, by-passing the conventional retailer, such as an on-campus college bookstore. Thus, in a conventional electronic textbook distribution model, the publisher is acting as both the distributor and the retailer, and is faced with the inherent problems of trying to market to the end-user student as well as providing customer service and support to such students. Publishers, however, are not the traditional contact point with the students for college course materials and, thus, have no direct marketing access to the consumer. Textbook publishers, schools, professors, and students all typically rely on the college bookstore for delivery of required course materials. With direct to consumer selling by publishers, the college bookstore retailer is no longer a part of the traditional delivery channel, denying them of the associated revenues and profits that may accrue from the sale of electronic course materials. In addition to the potential lost revenues facing the retailer, there is no practical way for a publisher to market electronic product directly to the consumer.

Moreover, a substantial number of students rely on some form of third party funding for textbooks and course materials. Publishers wanting to make electronic materials available to the consumer generally have no readily available mechanism for accepting third party payment options, eliminating what could be a significant portion of the potential market for electronic course materials.

A need exists, therefore, for an improved method and system for merchandising and distributing electronic books and other related digital content, including electronic books and course materials to students. Preferably, the method and system would include means for properly authorizing and securing access to the electronic books.

### SUMMARY OF THE INVENTION

The present invention includes a method for distributing and facilitating access to electronic books and other similar digital materials. The method includes first providing a digital book card having a card identification number and an activation code corresponding to the card identification number. The digital book card is also associated with an electronic book having an electronic book number. A retail store transaction is processed for the purchase of the electronic book associated with the digital book card. The retail store transmits the card identification number and the electronic book number to a central processor associated with a program administrator. The program administrator approves or declines the request and returns a receipt code to the retail store, which is then provided to the purchaser. A purchaser accessing a website associated with the central processor enters the card identification number, the activation code, and the receipt code. The purchase of the electronic book is authenticated in order to activate access to the electronic book by determining whether the card identification number entered by the purchaser corresponds to the activation code entered by the purchaser and whether the receipt code entered by the customer corresponds to the receipt code transmitted by the central processor to the retail store. If the authentication process is successful, access to the electronic book having the electronic book number associated with the card identification number is provided.

### BRIEF DESCRIPTION OF THE FIGURES

These and other features, aspects and advantages of the invention will become more fully apparent from the following detailed description, appended claims, and accompanying drawings, wherein the drawings illustrates a feature of the system and method in accordance with an exemplary embodiment of the present invention, and wherein:

FIG. 1 illustrates a representative digital book card that may be used with one embodiment of the system and method of the present invention;

FIG. 2 illustrates the reverse side of the representative digital book card of FIG. 1;

FIG. 3 is a flow chart depicting the principal steps in one embodiment of the method of the present invention;

FIG. 4 is a screen capture illustrating the initial home page for a website used in one embodiment of the method of the present invention;

FIG. 5 is a screen capture illustrating the activation page for a website used in one embodiment of the method of the present invention; and

FIG. 6 is a screen capture illustrating a detail page for a website used in one embodiment of the method of the present invention.

### DETAILED DESCRIPTION OF THE INVENTION

As used herein, the term electronic book or e-book includes all forms of digital books and related content, such as electronic or digital books, textbooks, workbooks, study aids and course materials. The term electronic book may also refer to other forms of digital content such as software, games, movies, music, and the like.

The method of the present invention for merchandising and distributing electronic books includes interaction among three principal entitles. First, there is a program administrator having responsibility for overall program management, including authenticating and providing access to the electronic books. The program administrator operates one or more computer systems having a database to store authorizing information. The computer system operated by the program administrator also operates a website used in the preferred method. Second, there is a conventional retailer who offers access to the electronic books for purchase. Third, there are the purchasers of the electronic books. The purchaser buys access to the electronic books from the retailer, who provides the purchaser with a series of access numbers or codes. The purchaser then makes contact with the program administrator, for example through the website maintained by the program administrator, and provides the access numbers or codes. The program administrator authenticates the purchase and, if appropriate, provides access to the electronic books to the purchaser.

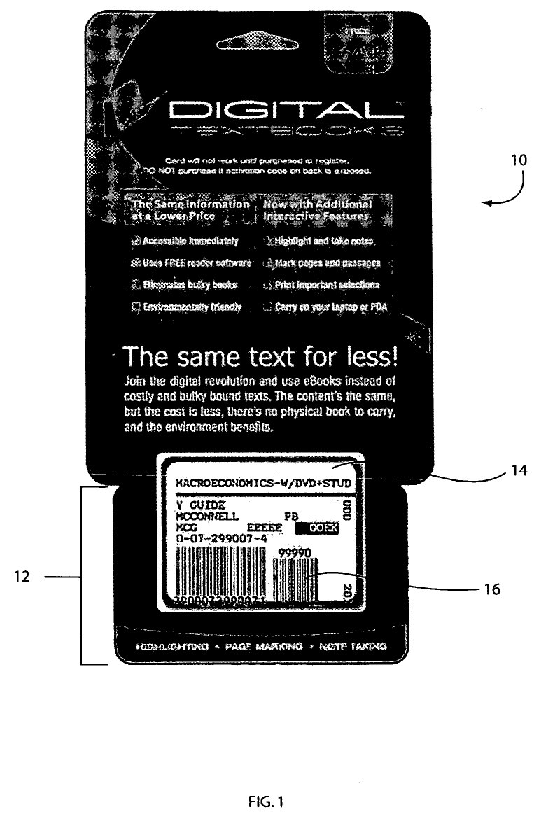

FIG. 1 illustrates a digital book card 10 that may be used in conjunction with the method for distributing electronic books. The initially generic card 10 may be made available to prospective purchasers of electronic or digital books and related materials or content. For example, in the college textbook scenario, the cards 10 may be placed in the textbook department of a conventional college bookstore, on the bookshelves adjacent to the used and new versions of the corresponding printed textbooks. The cards 10 may be displayed in a shelf merchandiser that is appropriately designed to show limited information about the electronic book represented by the card 10. In an alternative embodiment, the cards 10 may be stored within a dispenser or kiosk and only dispensed upon purchase. Preferably, the cards 10 are designed so that the retailer may create and place a label containing indicia representing the associated electronic book on the card 10. Placing the cards 10 strategically in the textbook department, displaying them along with the bound copies of the text, offers the consumer a choice between used print, new print, digital format, or a combination of print and digital format. With three products to choose from, and three price points, the student or other consumer is offered a choice that is an attractive alternative to higher priced new books.

The card 10 may be sufficiently sized to display marketing information on both sides of the card 10. For example, the card 10 may be approximately four inches wide and seven and three-quarters inches in length. If desired, the bottom portion 12 of the card 10 may be reduced in width to resemble a non-detachable credit card or gift card.

The card 10 contains various indicia to secure and authenticate the purchase of the electronic books. Each card 10 has a combination of unique identification numbers or codes, one of which associates the card 10 to a specific retailer. Each card is later associated with a specific sales transaction and an electronic book product.

A supply of cards 10 may be provided to retailers who agree to participate in the system managed by the program administrator. The retailer is typically responsible for associating an electronic book product to each card 10, although this may be accomplished by the program administrator or book publisher. For example, the retailer may affix or print a retailer-generated label 14 representing a specific electronic book product onto the bottom portion 12 of the card 10. The label 14 may identify the book by author, title, course name or number or any other related information. The retailer may use its inventory management system to create the label 14 containing the identity information as well as a bar code 16 representing the electronic book number, such as the International Standard Book Number (ISBN) assigned to the electronic book product. The retailer selects the electronic book number from a list provided by the program administrator or from a preexisting list of known book numbers, such as the ISBN system. As the card 10 is initially generic, any bar code 16 representing a specific book or electronic course materials ISBN may be placed on the bottom portion 14 of the card 10. The assignment of a specific textbook to a given card is accomplished at the time of purchase as described below. Alternatively, the assignment of a particular electronic book to a particular card may be accomplished during the purchase phase by the retailer's point-of-sale assembly or kiosk. The bar code 16 may be swiped, scanned or otherwise entered at the point-of-sale assembly as a part of the electronic book purchase and activation process. As will be appreciated by those skilled in the art, other means of identifying the electronic book may be used other than a bar code, such as a magnetic strip, RFID or means that may be detected optically. Alternatively, the electronic book may be designated by printed title or number on the card and manually entered into the point-of-sale assembly.

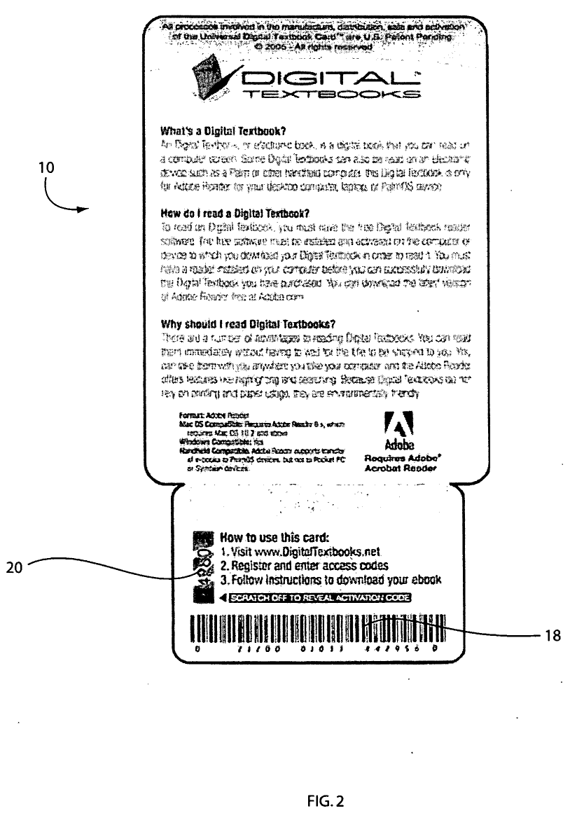

In addition to further marketing information, the reverse side of the card 10 may contain instructions for activating access to the electronic book product. As illustrated in FIG. 2, the card 10 may contain, for example, a card identification number 18, which may be represented in both numeric and bar code form or other computer or electronically readable form. Each card 10 used in the system bears a unique card identification number 18. The card identification number 18 may be placed on the card 10 as printed text, as a bar code, as a magnetic imprint, or by one or more other similar means. In addition, the card 10 contains a hidden activation code 20, which may also be placed on the reverse side of the card 10. The activation code 20 may be viewed, for example, by removing a scratch-off coating. As those skilled in the industry will appreciate, there are a number of other methods for hiding the activation code until the card is purchased. The activation code 20 may be randomly chosen and assigned to (corresponds with) one and only one card identification number 18 by the program administrator. Thus, the program administrator has a central processor that contains a database of card identification numbers and their corresponding activation codes. Preferably, both the card identification number 18 and the activation code 20 are placed on the card by the program administrator prior to delivery of the cards 10 to the retailer. In this manner, the program administrator may track the identity of the cards delivered to a particular retailer.

A card 10 is available for activation through a real-time point-of-sale activation process that may be accomplished through a secure TCP/IP connection from the retailer to the program administrator. The same process may also handle voids within the point-of-sale transaction and returns. Integration of the process to a retailer point-of-sale system may be accomplished using a socket application that allows for implementation to an existing installed base of retail bookstore management software. Alternatively, the application may be integrated with other conventional point-of-sale software, or even as a stand-alone application.

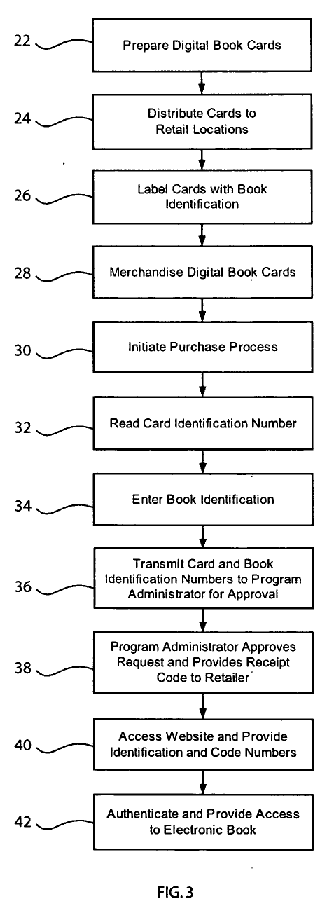

FIG. 3 is a flow chart depicting the principal steps in one embodiment of the method of the present invention. Initially, in step 22, the program administrator prepares a supply of cards 10, each having a unique card identification number 18 and a hidden, corresponding activation code 20 printed thereon. The pre-printed cards 10 are then distributed to retail locations such as college bookstores in step 24. Using the retailer's inventory management system, the retailer creates the label 14 that includes the identification of a particular book, e.g., bar code 16 and, if desired, other information related to an electronic book and, thus, places a label on each card in step 26.

The retailer then merchandises by electronic book by displaying the cards 10 as a conventional product available for purchase in step 28. When a purchaser such as a student desires to purchase access to the electronic book, he or she brings the appropriate card 10 to the retailer's point of sale system, which may include a conventional check-out register with an attendant or an operator-less kiosk or other form of self-checkout register (step 30). At the point of sale, the card 10 is presented to the point-of-sale system such as, for example, being passed through a card scanner or reader, by keying the card identification number, or any other means of entering the unique card identification number 18 into the point-of-sale system (step 32). Entering the card identification number into the point-of-sale system prompts the cashier or automated kiosk to associate the card 10 to a unique item, e.g., an electronic textbook. This may be accomplished by scanning in the bar code 16 on the front of the card 10 in step 34, which represents the specific book. Again, any other means of entering in the identification of the electronic book into the point-of-sale system may be used. At this point, a particular electronic book product is associated with a particular card identification number and activation code.

The retailer then notifies the program administrator with details of the transaction in step 36. For example, the transaction details may include the identify of the particular electronic book or other materials that was purchased and the particular card identification number associated with the purchase process. This information may be electronically transmitted to a central processor associated with the program administrator using, for example, a TCP/IP or UDP protocol connection. As this point, the program administrator has three pieces of information associated together: the card identification number, the activation code, and the identification of the electronic book. The program administrator returns an approval or decline code to the retailer, along with a unique receipt code. A receipt may be generated with the receipt code that will be used in order for the purchaser to later gain access to the electronic book (step 38). The receipt is generated (e.g., printed) by the retailer's point-of-sale assembly, which now contains a card identification number, a book identification number, and a receipt code, all of which correspond to one another. In the event the purchaser opts to purchase more than one electronic book in a single transaction, a single receipt code may apply for access to all of the purchased electronic books. The purchaser then completes the transaction in order to pay for the book(s) or other materials in a conventional manner. A student in a college setting may use conventional third-party funding means to complete the transaction.

In an alternative embodiment, the purchaser may use a card dispenser or kiosk to select the desired electronic book. The kiosk or dispenser may include conventional means for accepting payment from the purchaser, such as from a credit or debit card, or a bill and coin acceptor. Upon acceptance of the form of payment from the purchaser, the kiosk may dispense a card 10, having printed or otherwise affixed thereon the card identification number and activation code (which may or may not be hidden). A receipt may also be supplied having the receipt code printed thereon. Alternatively, the receipt code may be placed on the dispensed card 10. In this embodiment, the kiosk may be considered the “retailer.”

In step 40, the purchaser accesses a website affiliated with the program administrator. Preferably, the purchaser may gain information regarding the website (such as its web address) from the card 10 she acquired as part of the electronic book purchase at the retailer. Alternatively, the retailer may provide the purchaser with information regarding the website from other sales information posted in the store, from information printed on the receipt, on a brochure handed out with the purchase, or other means. The purchaser uses the website as a means of providing the program administrator with the card identification number, the hidden activation code, and the receipt code, which may then be used by the program administrator to authenticate and provide access to the electronic book (step 42).

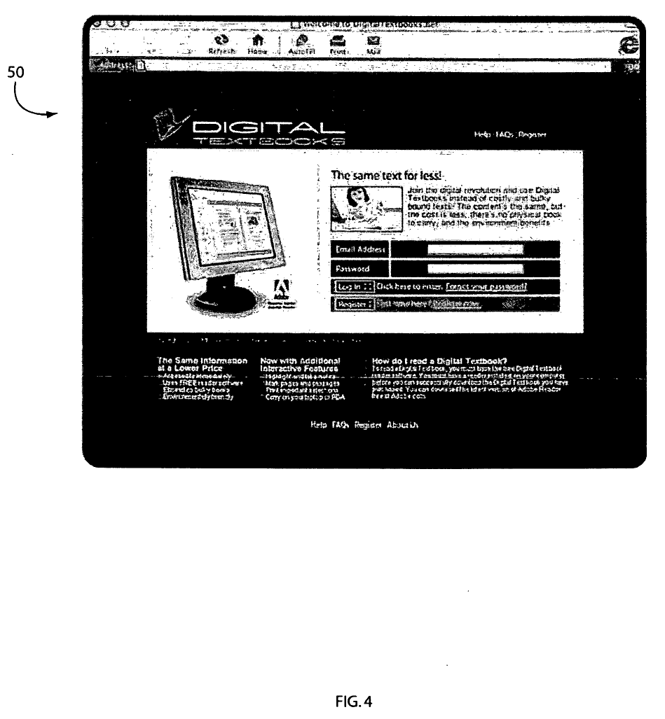

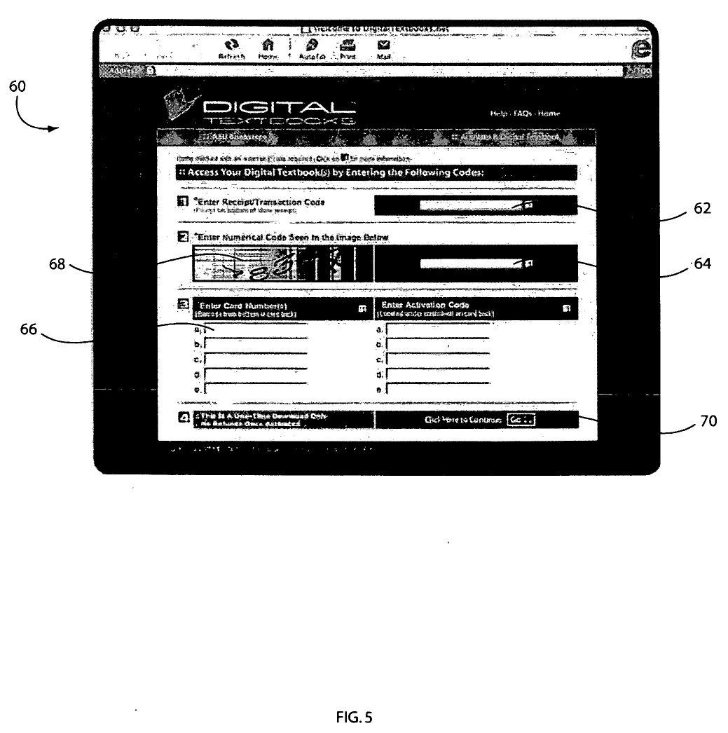

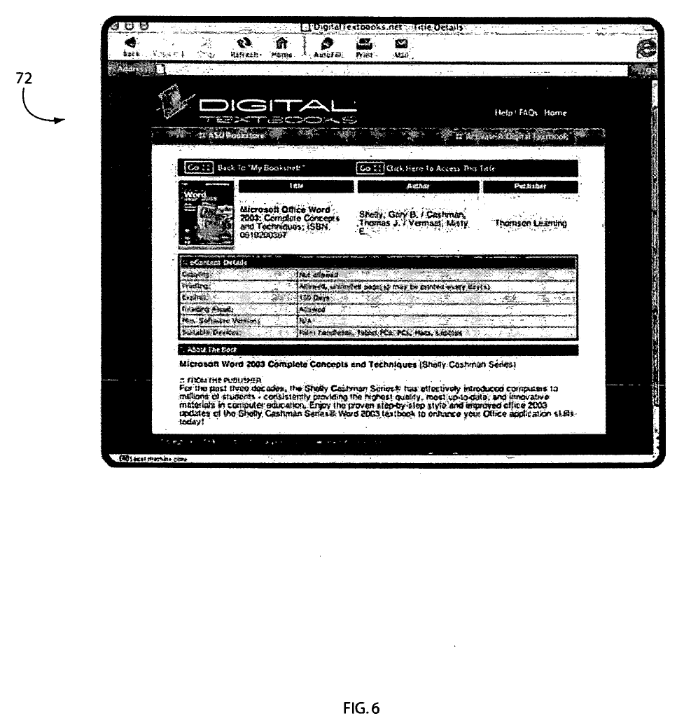

FIG. 4 depicts a representative screen shot for an initial home page 50 of a website operated by the program administrator. The initial home page 50 allows the purchaser to log in as an existing customer by, for example, providing an e-mail address and password or, alternatively, to register as a first time user by providing an e-mail address and adopting a password. After successfully completing the log-in or registration process, the purchaser is directed to an activation page 60 as depicted in FIG. 5. The activation page 60 has windows 62 and 66 for allowing the purchaser to enter in the receipt code, and the card identification number(s) and activation code(s) for each electronic book purchased. In addition, for added security, the activation page 60 may require the purchaser to replicate a randomly generated numerical code shown in an image box 68 in the box 64. Upon entering in the required information, the purchaser may click on an icon 70 to continue the activation process. The program administrator operating the website authenticates access to the electronic book by ensuring that the card identification number entered by the purchaser corresponds to the activation code entered by the purchaser and that the receipt code entered by the purchaser corresponds to the receipt code transmitted by the retail store to the program administrator. This access authentication is preferably performed by software executing in a central processor associated with the program administrator. Upon the successful entry of all four numerical identifiers, the purchaser is provided with instructions for accessing the electronic book, for example, by downloading the book to the purchaser's computer equipment or accessing it as online content. Upon activating access to a particular digital book, the purchaser may be provided with a book detail page 72 such as illustrated in FIG. 6, which provides further detailed information on the electronic book. For example, the book detail page 72 may inform the purchaser as to her rights to copy or print portions of the book or materials, the length of time that access to the book is active, the devices that are compatible with the electronic book format, and the like. The electronic book may be provided in an Adobe® PDF format, which may have built-in functions for highlighting, underlining, note creation, read-aloud capability, and other useful functions.

The program administrator may also provide an administrative page for retailers to assist in the management, activation, loss and return of electronic book cards.

The system and method of the present invention may be adapted for use with a retailer's on-line store. For example, a college student may access a college bookstore's website to purchase her books. If she elects to purchase an electronic book or digital course materials, she may pay for the book(s) and materials through the college bookstore's on-line store. She may then be presented or receive a receipt containing a combination of the above-described card identification number, activation code, and receipt code. With this information, she may then access the program administrator's website, present the numbers and codes as previously described, and gain access to the electronic book or other materials.

The method described herein enables college bookstores and other retailers to pro-actively market and sell electronic books and other course materials. The system and method allows the retailer to participate in the traditional, long-standing sales and marketing channel. The books and materials may either be downloaded to a computing device and accessed by means of existing computer or electronic book readers, or the books and materials may be accessible as on-line content from various secure web sites. In addition, the system and method described herein allows a purchaser to purchase an electronic book from a retailer using third-party funding, thus addressing the publishers general inability to accept methods of payment other than credit card or electronic check.

Although the invention has been described with reference to specific embodiments, as will be understood by those skilled in the art, other embodiments and variations may be made without departing from the spirit or scope of the invention. The many aspects and benefits of the invention are apparent from the detailed description, and thus, it is intended for the following claims to cover all such aspects and benefits of the invention which fall within the scope and spirit of the invention. For example, although most of the embodiments discussed herein relate to the distribution of digital textbooks in a collegiate setting, the method disclosed herein may also be used to distribute other forms of digital content, such as software, games, movies, music, and the like. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A method for distributing electronic books comprising the steps of:
providing a digital book card having a card identification number and an activation code corresponding to the card identification number;
associating an electronic book having an electronic book number with the digital book card;
processing a transaction at a retail store for the purchase of the electronic book associated with the digital book card by the retail store transmitting the card identification number and the electronic book number to a central processor;
the central processor approving the transaction, generating a receipt code, and transmitting the receipt code to the retail store;
a purchaser accessing a website associated with the central processor and entering the card identification number, the activation code, and the receipt code;
authenticating the purchase of the electronic book in order to activate access to the electronic book by determining whether the card identification number entered by the purchaser corresponds to the activation code entered by the purchaser and whether the receipt code entered by the customer corresponds to the receipt code transmitted by the central processor; and
providing access to the electronic book having the electronic book number associated with the card identification number.

2. The method of claim 1 wherein the digital book card further includes a hidden activation code uniquely associated with the card identification code, wherein the purchaser accessing the website exposes and enters the activation code, and wherein the step of authenticating the purchase of the electronic book further comprises the step of verifying that the entered activation code is properly associated with the card identification code.

3. The method of claim 1 wherein the step of providing access to the electronic book comprises the step of allowing the purchaser to download a copy of the electronic book.

4. The method of claim 1 wherein the step of providing access to the electronic book comprises the step of granting the purchaser on-line access to the electronic book.

5. The method of claim 1 further comprising the step of instructing the purchaser to access the website on a computer system over a network.

6. The method of claim 1 wherein the card identification number is uniquely associated with the retail store.

7. The method of claim 1 wherein the card identification number is located on the card in machine readable format.

8. The method of claim 1 wherein the step of associating an electronic book further comprises the step of placing the electronic book number on the digital book card.

9. The method of claim 8 wherein the step of processing a transaction further comprises reading the card identification number and book identification number from the digital book card.
